(19) United States
(12) Patent Application Publication
(10) Pub. No.: US 2022/0250455 A1
(43) Pub. Date: Aug. 11, 2022

(54) Cargo-Bed Cover System and Method

(71) Applicant: Brent Wesley Trinier, Calgary (CA)

(72) Inventor: Brent Wesley Trinier, Calgary (CA)

(21) Appl. No.: 17/064,273

(22) Filed: Feb. 5, 2021

(51) Int. Cl. B60J 7/16

(52) U.S. Cl. CPC B60J 7/1614

(57) ABSTRACT

A cargo-bed cover system and method as used to improve the covering of cargo beds of pickup trucks by providing an apparatus having the functionality of both a truck topper and a hard top tonneau cover. The cargo-bed cover system includes a rigid cover configured to cover the cargo bed of the pickup truck; coupled to the rigid cover, a mechanically powered scissor lift assembly configured to vertically lift the rigid cover between a bed-covering position, located adjacent the cargo bed, and at least one raised position located above the cargo bed; and a mounting assembly configured to removably mount the mechanically powered scissor lift assembly to the cargo bed.

### CROSS-REFERENCE TO RELATED APPLICATION(S)

The present application is a Continuation-in-Part and is related to and claims priority to pending U.S. Non-Provisional patent application Ser. No. 15/689,935 filed Aug. 29, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of bodies and tops for land vehicles of existing art and more specifically relates to land-vehicle tops, capable of a vertical lifting movement.

### RELATED ART

Tonneau covers, bed toppers, and similar enclosures are useful to provide security and weather protection for items being transported in the cargo bed of a pickup truck, for example. Unfortunately, tonneau covers limit the size of items that can be transported, and toppers are heavy and difficult to install and remove from the pickup truck bed when not required. A selectively extendable tonneau structure that may be easily opened to form an enclosed topper (camper) and readily collapsed when not in use to cover the pickup truck bed at a level below the rear window of the truck cab would benefit many.

Prior attempts have been made to address the above-noted problems; for example, U.S. Pat. No. 6,209,944 to Billiu et al. relates to a stowable truck bed enclosure. The described stowable truck bed enclosure includes a stowable top or cover mounted on an open bed of a truck, such as a pickup truck, using lift frames and actuators in a manner to be raised above the bed. The cover and lift frames include attachment channels for connecting a flexible tent-like enclosure thereto such that the enclosure can be attached thereto after the cover is raised. The flexible enclosure can comprise a camper enclosure that encloses the truck bed and also optionally can extend beyond the truck bed to form additional sitting and sleeping rooms supported on separate portable tent-type posts and platforms. A flexible awning enclosure can be attached to the raised cover and lift frames to form an awning that extends beyond the truck bed supported on separate tent-type posts to provide a covered area for on-site work, commercial, or recreational activities. An office enclosure can be attached to the raised cover and lift frames to form an office or meeting room where job-site work/meetings and the like can be conducted protected from the weather. The apparatus of Billiu et al. has several disadvantages in that the flexible enclosure of must be installed after raising the cover and must be removed before operation of the vehicle.

### SUMMARY OF THE INVENTION

In view of the foregoing disadvantages inherent in the known art relating to land-vehicle tops, capable of a vertical lifting movement, the present disclosure provides a novel cargo-bed cover system and method. The general purpose of the present disclosure, which will be described herein, is to provide an apparatus having the functionality of both a truck topper and a hard-top tonneau cover.

A cargo-bed cover system is disclosed herein. The cargo-bed cover system may include a rigid cover configured to cover the cargo bed of the pickup truck; coupled to the rigid cover, a mechanically powered scissor lift assembly configured to vertically lift the rigid cover between a bed-covering position, located adjacent the cargo bed, and at least one raised position located above the cargo bed; and a mounting assembly configured to removably mount the mechanically powered scissor lift assembly to the cargo bed rail. The rigid cover may be constructed from at least one fiber-reinforced plastic composite. According to one embodiment, the cargo-bed cover system may be arranged as a kit.

In an alternative embodiment, a rigid cover configured to cover the cargo bed of the pickup truck; coupled to the rigid cover, a mechanically powered lift assembly configured to vertically lift the rigid cover between a bed-covering position, located adjacent the cargo bed, and at least one raised position located above the cargo bed; a mounting assembly configured to removably mount the mechanically powered scissor lift assembly to the cargo bed; a pair of enclosing side panels configured to enclose an area formed between a side portion of the rigid cover and the cargo bed when the rigid cover is in the at least one raised position, each of such enclosing side panel(s) being constructed from at least one flexible sheet material; a set of stabilizing support cables configured to stably support the flexible sheet material of the enclosing side panels during operation of the pickup truck; at least one cable tensioner adapted to maintain the stabilizing support cables in a state of tension as the rigid cover is lifted vertically between the bed-covering position and the at least one raised position; an enclosing-front-panel configured to enclose a space formed between a front portion of the rigid cover and the cargo bed when the rigid cover is in the at least one raised position; and an enclosing-rear-panel configured to enclose a space formed between a rear portion of the rigid cover and a tailgate of the cargo bed when the rigid cover is in the at least one raised position. In addition, the enclosing-rear-panel may be constructed from the at least one flexible sheet material. The rigid cover may be constructed from at least one fiber-reinforced plastic composite.

Moreover, the enclosing-front-panel may include at least one transparent front window and the enclosing-rear-panel may include at least one transparent rear window, wherein the at least one transparent rear window may include a releasable window fastener configured to releasably fasten the at least one transparent rear window within the enclosing-rear-panel. The at least one transparent rear window may be removable from the enclosing-rear-panel. Each of such enclosing side panel(s) may also include at least one transparent window.

The mounting assembly may include a front frame section including a front-frame attacher configured to removably attach the front frame section to a top surface of a front wall of the cargo bed. The mounting assembly may further include a first sidewall-frame section including a first-sidewall-frame attacher configured to removably attach the first sidewall frame to a top surface of a first sidewall of the cargo bed and a second sidewall-frame section including a second-sidewall-frame attacher configured to removably attach the second sidewall frame to a top surface of a second sidewall of the cargo bed.

Each of the enclosing side panels may comprise a set of cable receivers configured to receive stabilizing support cables. The set of cable receivers are further adapted to couple the two stabilizing support cables to a respective one of the enclosing side panels. Each of such enclosing side panels may be supported by two or more stabilizing support cables.

Each one of the stabilizing support cables comprise a first cable end and a second cable end. The first cable end may include a first-end coupler adapted to releasably couple the first cable end to the rigid cover. The second cable end may include a second-end coupler adapted to releasably couple the second cable end to the mounting assembly.

The mechanically powered scissor lift assembly may be electrically actuated. The mechanically powered scissor lift assembly may comprise an electrical connector adapted to connect the mechanically powered scissor lift assembly to an electrical power source of the pickup truck and at least one user-operable control unit configured to enable user control of the operation of the mechanically powered scissor lift assembly.

The enclosing-rear-panel may comprise a rigid transverse bar configured to rigidly support a lower edge portion of the enclosing-rear-panel in a position adjacent the tailgate. The rigid transverse bar may include a set of bar-end couplers adapted to releasably couple the rigid transverse bar to the mounting assembly. The mounting assembly may comprise a set of clamps adapted to releasably clamp the mounting assembly to the cargo bed.

Moreover, it provides such a cargo-bed cover system, further comprising set of instructions; and wherein the cargo-bed cover system may be arranged as a kit.

In accordance with another preferred embodiment hereof, this invention provides a cargo-bed cover method, the method comprising the steps of: providing a rigid cover configured to cover the cargo bed of the pickup truck; providing a mechanically powered scissor lift assembly configured to vertically lift the rigid cover between a bed-covering position located adjacent the cargo bed and at least one raised position located above the cargo bed; operably coupling the mechanically powered scissor lift assembly to the rigid cover; providing a mounting assembly configured to removably mount the mechanically powered scissor lift assembly to the cargo bed; providing a pair of enclosing side panels configured to enclose an area formed between a side portion of the rigid cover and the cargo bed when the rigid cover is in the at least one raised position, each of such enclosing side panels being constructed from at least one flexible sheet material; providing a set of stabilizing support cables configured to stably support the flexible sheet material of the enclosing side panels during operation of the pickup truck; and integrating the stabilizing support cables within the flexible sheet material of the enclosing side panels. Additionally, it provides such a method further comprising the steps of providing at least one cable tensioner adapted to maintain the stabilizing support cables in a state of tension as the rigid cover is lifted vertically between the bed-covering position and the at least one raised position.

### BRIEF DESCRIPTION OF THE DRAWINGS

The figures which accompany the written portion of this specification illustrate embodiments and methods of use for the present disclosure, a cargo-bed cover system and method, constructed and operative according to the teachings of the present disclosure.

FIG. 1 is a perspective view of the cargo-bed cover system during an ‘in-use’ condition.

FIG. 2 is a perspective view of the cargo-bed cover system of FIG. 1.

FIG. 3 is a front view of the cargo-bed cover system of FIG. 1, showing the system configured as a tonneau-like cover.

FIG. 4 is a top perspective view of the cargo-bed cover system of FIG. 1, illustrating the system in a transitional (semi-raised) configuration.

FIG. 5 is an exploded view of the cargo-bed cover system of FIG. 1, illustrating the system in a truck topper configuration.

FIG. 6 is a flow diagram illustrating a method related to covering a cargo bed.

FIG. 7 is a perspective view of a portion of the lift system.

FIG. 8 is a perspective view of another version of the cover, retracted.

FIG. 9A is a top view of the cover version of FIG. 8.

FIG. 9B is a side view of the cover version of FIG. 8.

FIG. 10 is a perspective view of another version of the cover, raised.

FIG. 11A is a top view of the cover version of FIG. 10.

FIG. 11B is a side view of the cover version of FIG. 10.

FIG. 12 is a blown up view of a lift mechanism.

FIG. 13 is a perspective view of another version of the cover, raised.

The various embodiments of the present invention will hereinafter be described in conjunction with the appended drawings, wherein like designations denote like elements.

### DETAILED DESCRIPTION

As discussed above, embodiments of the present disclosure relate to land vehicle tops and more particularly to a cargo-bed cover system and method as used to improve the covering of cargo beds of pickup trucks utilizing an apparatus having the functionality of both a truck topper and a hard-top tonneau cover.

Generally, the system is a truck box tonneau cover (hard-cover top) that can lift via electric, spring, or hydraulic lifters until the tonneau cover reaches the level of the truck cab. The hard top tonneau cover may be chosen from a variety of options. For example, the hard top tonneau cover may fold or roll up and can be a single-piece fiberglass, metal, or similar structure. A scissor lift mechanism is alternately provided to raise and lower the tonneau cover hard lid. In some embodiments, the scissor lift mechanism includes a scissor lift on each side of the tonneau cover positioned along an aluminum bed rail frame.

In an alternative embodiment, the device includes a set of enclosing panels comprising canvas or other flexible material used to enclose the sides and rear of the bed when the tonneau cover is raised to the elevation flush with the truck cab roof line or above the roof line for loading and unloading of objects, if required. In the raised configuration, the enclosing panels can completely enclose the cargo bed and effectively convert the tonneau cover into a truck topper. When raised above the roof line, the canvas panels may be detached, allowing the rigid tonneau cover to be raised to fit oversized objects, then lower back down to flush with the roof of the truck cab for driving conditions.

The enclosing panels may include windows, as will be described in greater detail below. Portions or the entire enclosing panels may be detached from the assembly, which allows for cargo to be loaded over the side of the truck and into the truck bed, if necessary, while the hard-cover top is in the fully raised position, or above the roof line for loading & unloading of objects if required.

The enclosing panels may be constructed from canvas or a similar flexible and water-resistant material. The system can be locked and unlocked to secure contents at a top or bottom position. The unit sits on the bed rails of the pickup truck and can be removed as a single unit for storage.

A flexible back panel/window may be provided to enclose the rear of the bed when the hard tonneau cover is in the raised position. The back panel is configured to roll up and down and may include a rigid transverse bar extending along the base of the flexible back panel. In one version of the apparatus, the three flexible panels used to enclose the truck bed contents are constructed from a heavy duty canvas, or similar material. The flexible panels may be supplied with or without the above-noted vinyl windows.

The design includes an arrangement of panel-supporting cables, allowing the apparatus to be durable enough to be deployed at highway speeds factoring in the wind loading, snow, rain, etc. The cables supporting the flexible vinyl/canvas sides are held under constant tension to provide a tight line along which the canvas/vinyl panels may expand and contract. The flexible vinyl/canvas panels are configured to fold in a manner similar to the way that window blinds fold, stack, and expand. The flexible panels include grommets that are installed within the fabric/canvas/vinyl. The cables slide within the grommets, thus ensuring the flexible material is not subjected to excessive wear and abrasion. This arrangement allows for the canvas to be snug fitting to prevent undesirable wind-induced aerodynamic oscillations in the fabric panels during driving conditions.

The design utilizes a set of three mounting rails on which the tonneau cover rests when lowered. The mounting rails are clamped, or otherwise secured, to the bed rails of the truck box in a manner allowing the cover assembly to be quickly lifted off as one piece (tonneau lid, bed rails, canvas sides, and lifting mechanism joined as one fixed-together unit). One advantage of the single-unit arrangement is that a user is able to store the entire apparatus neatly against a wall of a garage, or the apparatus may be hoisted into the ceiling of a garage to get it out of the way, or to use the truck bed without the topper setup on the truck, for normal truck utility purposes. The cables supporting the flexible enclosing panels are maintained in constant tension, to limit undesirable wind-induced aerodynamic oscillations in the fabric panels during driving conditions.

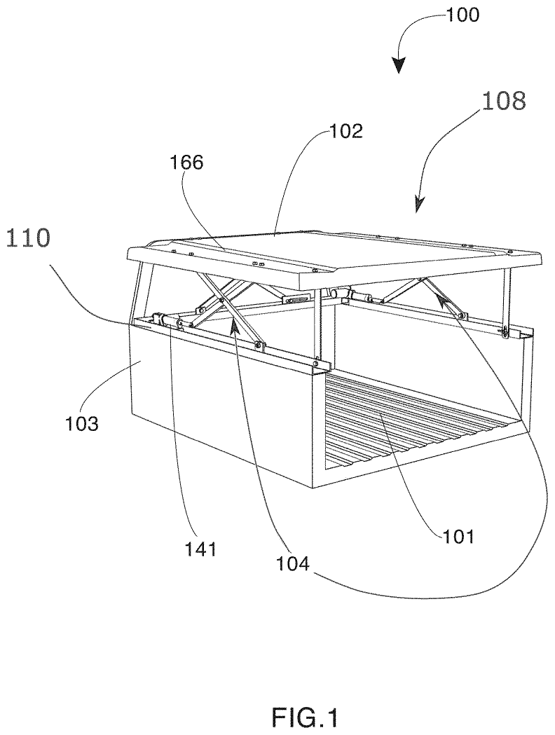

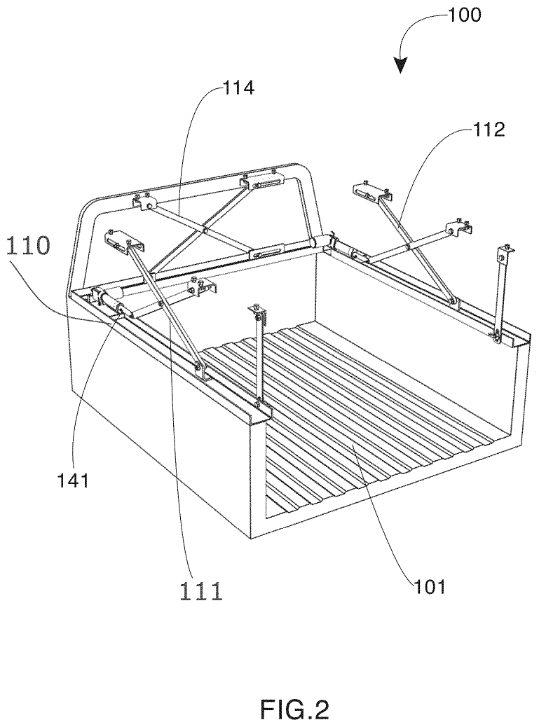

Referring now more specifically to the drawings by numerals of reference, there is shown in FIGS. 1-5, various views of a cargo-bed cover system 100. FIG. 1 shows a cargo-bed cover system 100 during ‘in-use’ conditions 50. Here, the cargo-bed cover system 100 may be beneficial for use by a user to enclose the cargo bed 101 of a vehicle, such as, a pickup truck 103. A principal feature of the cargo-bed cover system 100 is the ability of the system to transform from a tonneau-like cover, shown in FIG. 1, to a truck topper, as shown in FIG. 2.

A mechanically powered scissor lift assembly 104 is provided in particular embodiments to vertically lift the rigid cover 102 between the bed-covering position, located adjacent the cargo bed 101, and the raised position 108 located above the cargo bed 101. The mechanically powered scissor lift assembly 104 comprises a first-scissor-lift 110 and a second-scissor-lift 112 positioned on opposing sides of the cargo bed 101. The mechanically powered scissor lift assembly 104 further includes locking pins for securing the mechanically powered scissor lift assembly 104 in a position. These locking pins increase the structure's rigidity. The lifting actuators 141 of the mechanically powered scissor lift assembly 104 are electrically powered linear actuators. The electrical power source may be 12-volt electrical power from the battery of the pickup truck 103. At least one user-operable control unit with a button control may be provided to enable user control of the operation of the mechanically powered scissor lift assembly 104. Under appropriate circumstances, considering such issues as user preferences, design preference, structural requirements, marketing preferences, cost, available materials, technological advances, etc., other actuator arrangements such as, for example, air-assisted units, hydraulic, pistons, screws, jacks/scissor lifts, manually-operated units, spring assisted units, gas-shock assisted units, etc., may be sufficient.

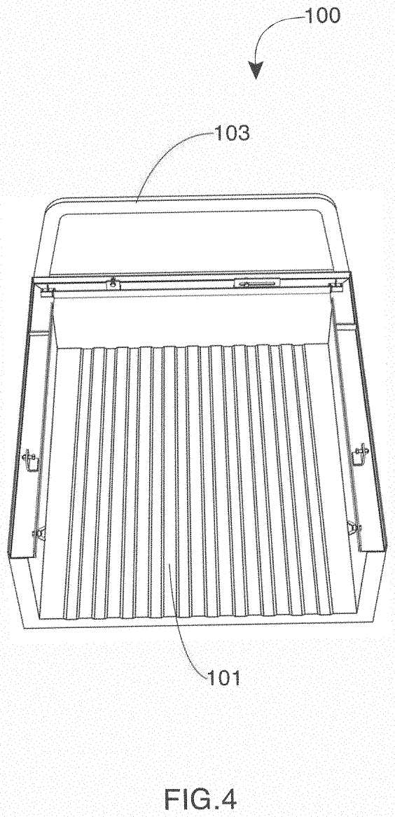

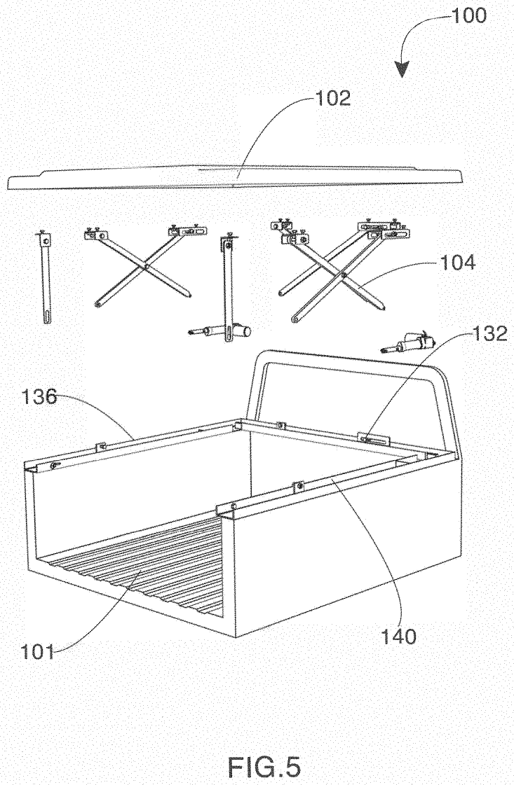

The cargo-bed cover system 100 is configured to allow the rigid cover 102 to be raised from the tonneau-like cover configuration, located adjacent to and covering the cargo bed 101, to at least one raised position 108 located above the cargo bed 101, as shown in FIG. 4 and FIG. 5. The rigid cover 102 may be raised above the cab of the pickup truck 103 to allow the loading of larger objects such as all-terrain vehicles, snowmobiles, motorcycles, tall objects, etc. After the cargo is loaded, the rigid cover 102 may be lowered to a level substantially flush with the top of the truck cab top level, and again locked into place.

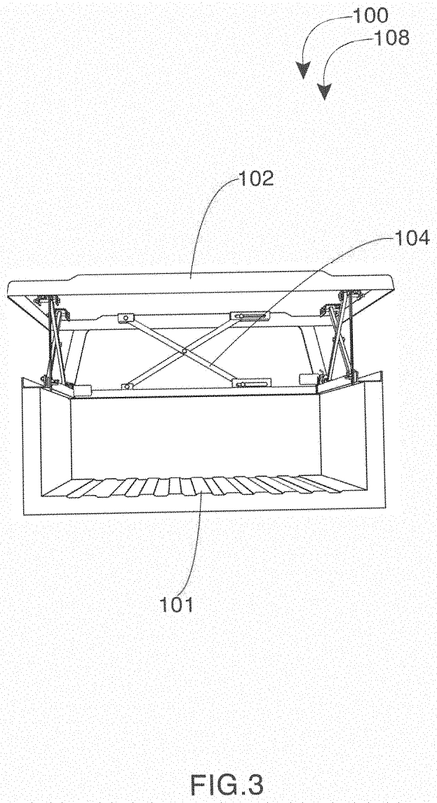

The rigid cover 102 of the cargo-bed cover system 100 is designed to move from a lowered position to a raised position 108 generally matching the elevation of the roof line of the cab of the pickup truck 103, as shown in FIG. 1 and FIG. 3. Alternately, the rigid cover 102 may be raised above the roof line for loading and unloading of objects if required. The rigid cover 102 may be constructed from one or more fiber-reinforced plastic composites. Alternately, the rigid cover 102 may be constructed from one or more aluminum alloys/metals and/or similar lightweight but rigid materials. The cargo-bed cover system 100 may further comprise reinforcing members for installing underneath the rigid cover to reinforce the rigid cover. The reinforcing members may be aluminum, steel, or other rigid material to prevent collapsing of the rigid cover 102. The rigid cover 102 further comprises accessory receiving attachments 166 configured to removably receive at least one accessory such as mounting bars, tie-down hooks/cargo restraints, rails, storage bags, cargo boxes, toolbox attachments, racks etc. The cargo-bed cover system 100 may further include a roll-down bar including a flexible material. In some versions of the present system, rigid cover 102 may be equipped with accessory receiving attachments 166 attached to the top surface. Such accessory receiving attachments 166 allow for aftermarket rails, cargo storage containers, bike racks, kayaks, canoes, ski, and snowboard racks, etc. to be installed to the top surface of rigid cover 102.

In certain embodiments, the cargo-bed cover system 100 utilizes a mounting assembly 110 composed of three frame sections, as shown. More specifically, the mounting assembly 110 may include a front frame section 132, a first sidewall-frame section 136, and a second sidewall-frame section 140, as shown. The front frame section 132 may include a front-frame attacher configured to removably attach the front frame section 132 to a top surface of a front wall of the cargo bed 101. The first sidewall-frame section 136 may include a first-sidewall-frame attacher configured to removably attach the first sidewall frame section 136 to a top surface of a first sidewall of the cargo bed 101. The second sidewall-frame section 140 may include a second-sidewall-frame attacher configured to removably attach the second sidewall frame section 140 to a top surface of a second sidewall of the cargo bed 101. The front-frame attacher, the first-sidewall-frame attacher, and the second-sidewall-frame attacher may each be a set of clamps adapted to releasably clamp the mounting assembly 110 to the cargo bed 101. The clamps may be C-shaped clamps with a nut and bolt to tighten and secure the three frame sections in place to the bed rails of the cargo bed 101 using only a wrench.

The mounting assembly 110 allows the assembly to be quickly lifted off as one piece (the components of the system joined as one fixed-together unit). Alternately, other clamping and/or fastening devices may be utilized to secure the three frame sections in place to the bed rails of the cargo bed 101. For structural rigidity, the corners of the frame sections may be supplied with diagonal stabilizer bars to connect the sidewall-frame sections to the front frame section 132 (i.e., each corner including a brace arranged to form a triangle in the two front corners so that the three frame sections are stabilized when removed from the truck bed rails).

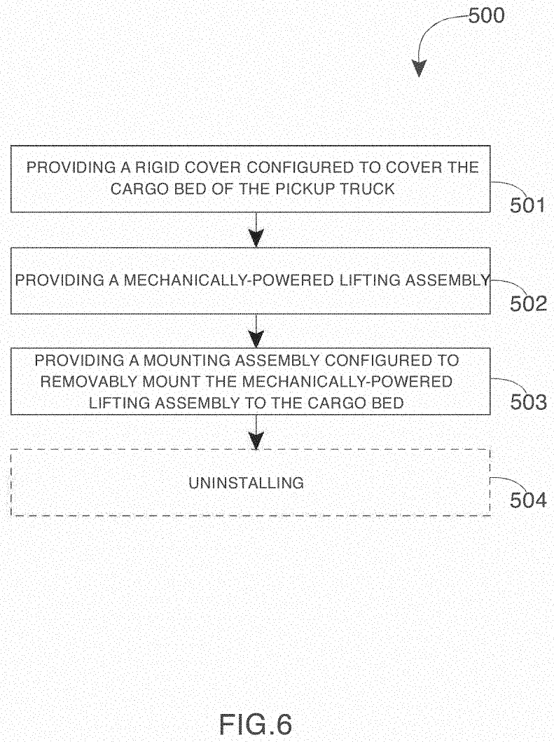

FIG. 6 is a flow diagram illustrating a method for enclosing the cargo bed of a pickup truck. In particular, the method 500 may include one or more components or features of the cargo-bed cover system 100 as described above. As illustrated, the method 500 may include the steps of: step one 501, providing a rigid cover configured to cover the cargo bed of the pickup truck; step two 502, providing a mechanically powered scissor lift assembly configured to vertically lift the rigid cover between a bed-covering position located adjacent the cargo bed and at least one raised position located above the cargo bed and operably coupling the mechanically powered scissor lift assembly to the rigid cover; step three 503, providing a mounting assembly configured to removably mount the mechanically powered scissor lift assembly to the cargo bed; step four 504, uninstalling the rigid cover and the mechanically powered scissor lift assembly from the cargo bed.

It should be noted that step 504 is an optional step and may not be implemented in all cases. Optional steps of method 500 are illustrated using dotted lines in FIG. 6 so as to distinguish it from the other steps of method 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for enclosing the cargo bed of a pickup truck [NOTE: e.g., different step orders within above-mentioned list, elimination or addition of certain steps, including or excluding certain maintenance steps, etc.], are taught herein.

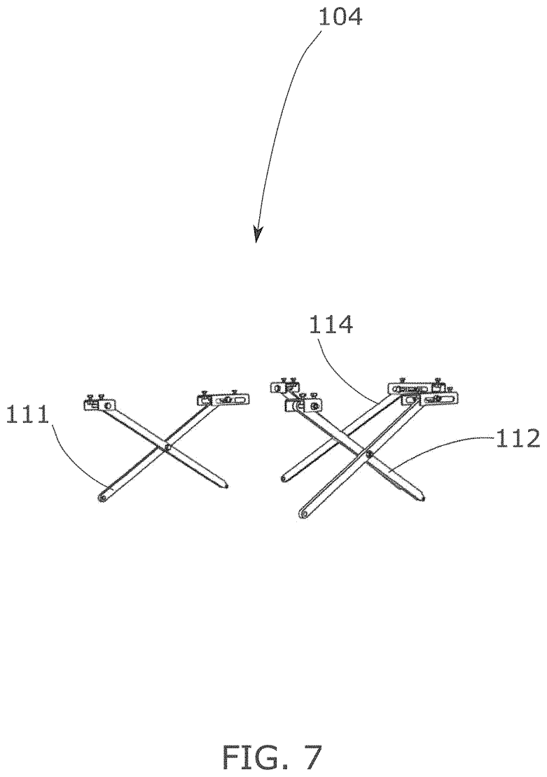

FIG. 7 depicts the scissor lift assembly 104 with individual scissor-lifts 111, 112, 114. The remainder of the components of the scissor lift assembly 104 is removed to clarify the figure.

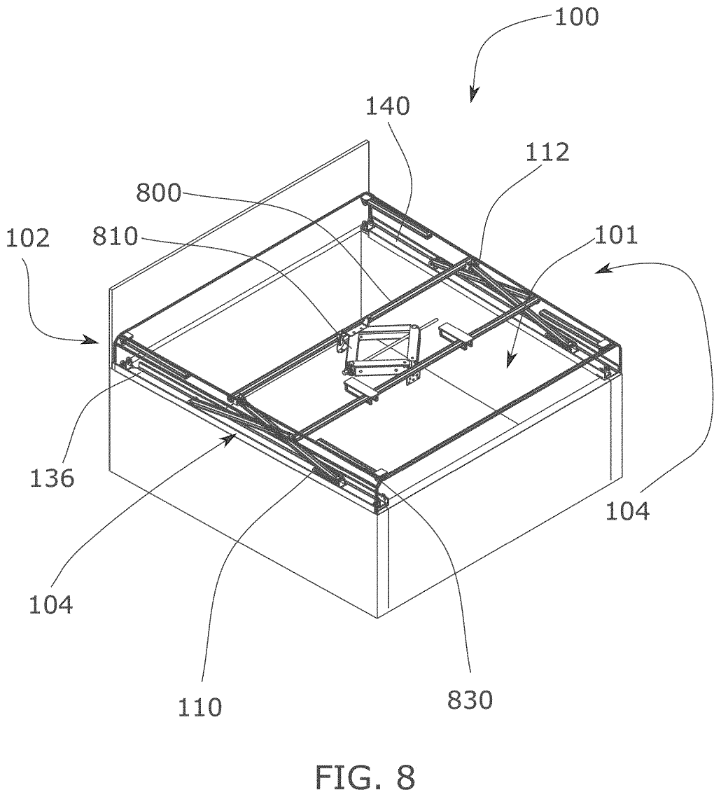

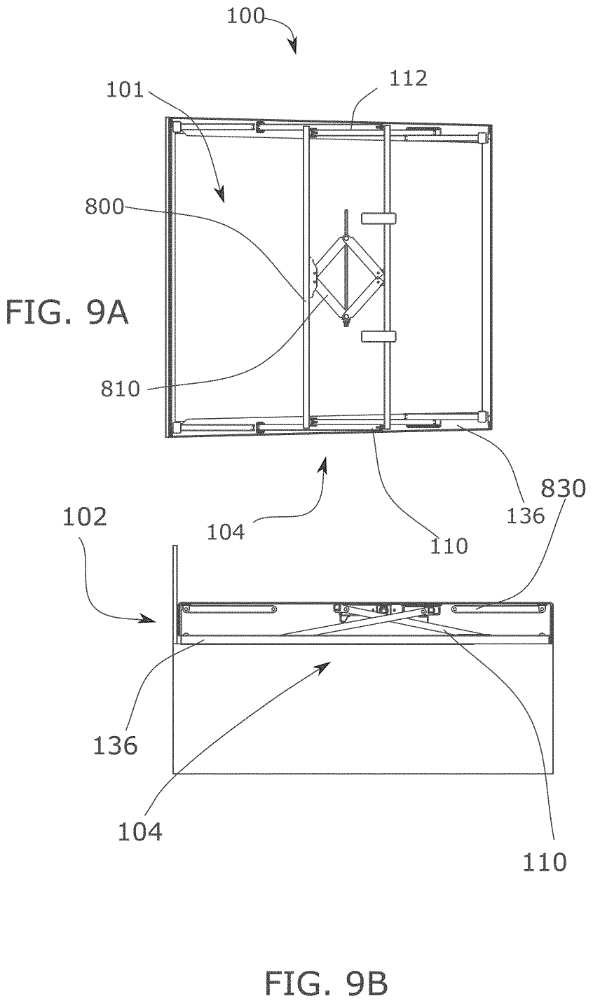

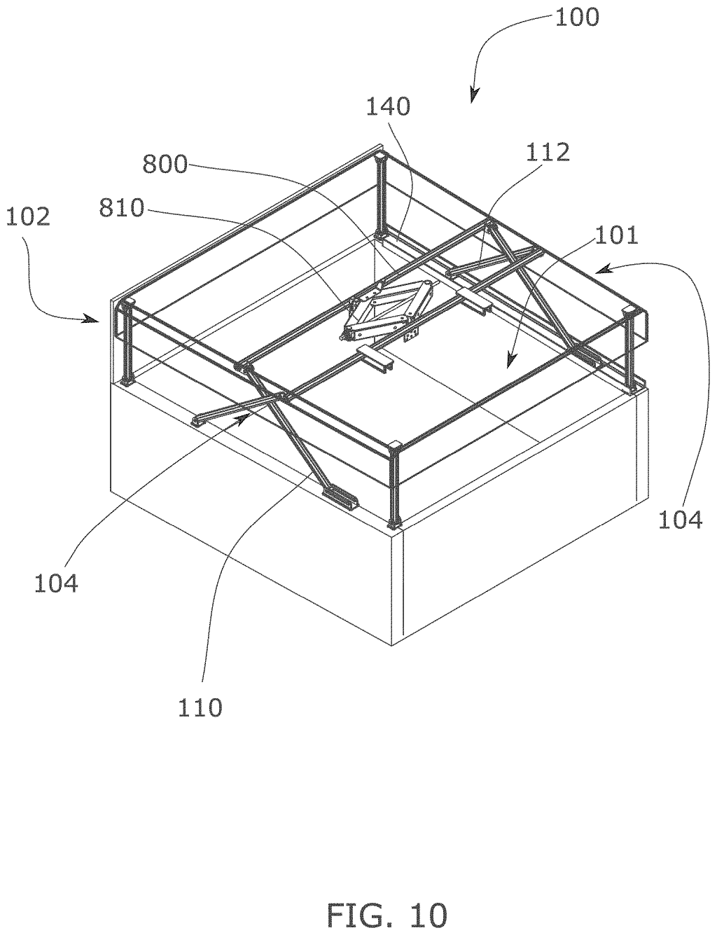

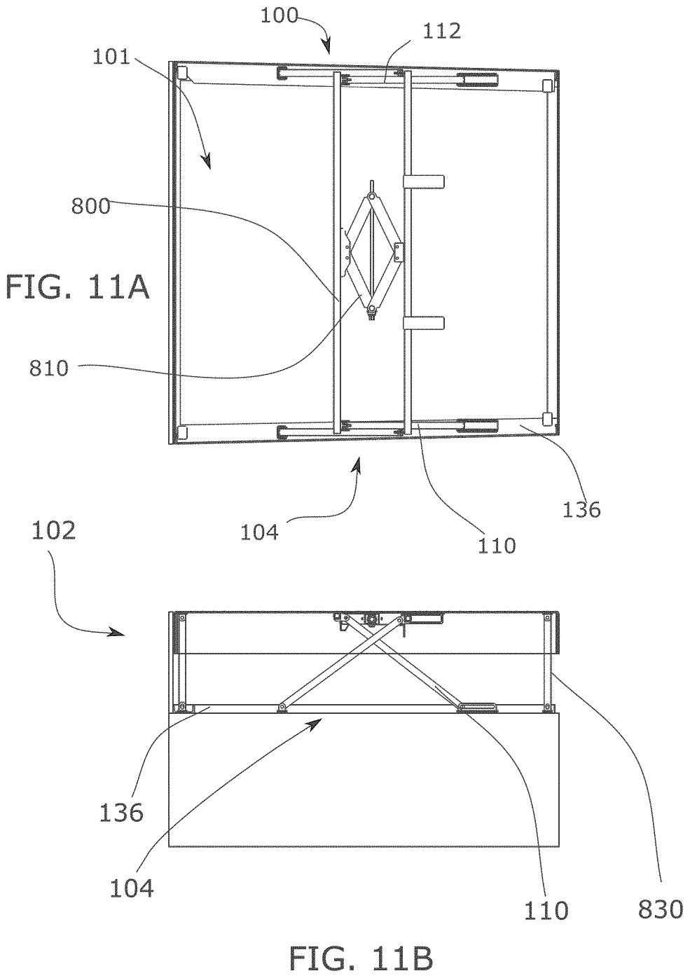

Referring now more specifically to the drawings by numerals of reference, there is shown in FIGS. 8-12, various views of a cargo-bed cover system 100. FIG. 8 shows a cargo-bed cover system 100 during the ‘in-use’ condition. Here, the cargo-bed cover system 100 may enclose the cargo bed 101 of a vehicle, such as a pickup truck. A principal feature of the cargo-bed cover system 100 is the ability of the system to transform from a tonneau-like cover, shown in FIG. 8, to a truck topper, as shown in FIG. 10. In this position, the cargo-bed system 100 is raised up. FIGS. 9AB and 11AB show top and side views of the cover position and the topper position, respectively.

A mechanically powered scissor lift assembly 104 is provided in particular embodiments to vertically lift the rigid cover 102 between the bed-covering position, located adjacent to the cargo bed 101, and the raised position located above the cargo bed 101. The mechanically powered scissor lift assembly 104 comprises a first-scissor-lift 110, and a second-scissor-lift 112 positioned on opposing sides of the cargo bed 101. The mechanically powered scissor lift assembly 104 further includes locking pins for securing the mechanically powered scissor lift assembly 104 in a position. As shown in these figures, one bar or rigid bar 800 or a pair of these bars 800 bridge between first-scissor lift 110 and second-scissor lift 113. This increases the rigidity of the structure and allows a single scissor-type actuator 810 to raise and lower the cargo-bed system 100. This increased rigidity allows for items to be mounted on top of the rigid cover 102. These items could include mounting bars, tie-down hooks, cargo restraints, rails, storage bags, cargo boxes, toolbox attachments, racks, etc. Those of ordinary skill in the art know of many aftermarket accessories for trucks to attach bikes, toys, storage, tools, etc., that would be suitable for top mounting on the rigid cover 102.

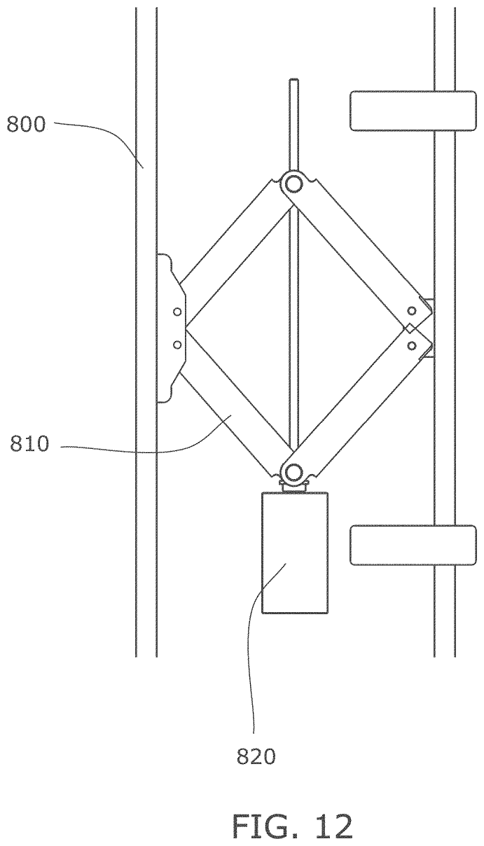

In some versions, the scissor-type actuator 810 is powered by an electric motor 820. (shown in FIG. 12) The electrical power source may be 12-volt electrical power from the battery of the vehicle. At least one user-operable control unit with a button control (not shown) may be provided to enable user control of the operation of the mechanically powered scissor lift assembly 104.

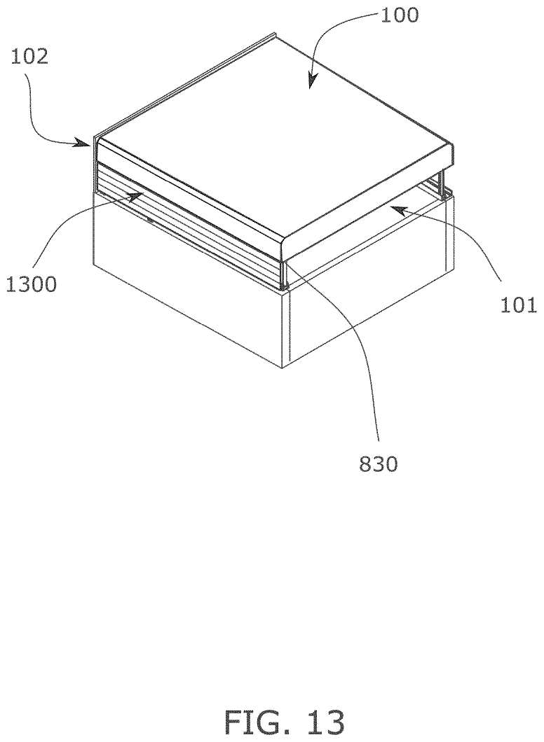

In any of the rigid-cover versions, the device can have bellows 1300 fastened between the rigid cover 102 and the sidewall-frame sections 136, 140. These bellows extend when the rigid cover 102 is raised, allowing for the desired increased height in the truck bed 101 under the cover 102 and provide shelter from the elements along the front, sides, and back or any combination of these. See FIG. 13. The bellows 1300 can be constructed of any number of materials such as KEVLAR, metal plates, coated fabrics, plastics, rubber, PVC, canvas, transparent fabrics. vinyl, or other sheeting materials. In some versions, the bellows contain windows, such as transparent windows, to see into and out of the bed 101. The bellows 1300 are glued, stitched or high-frequency welded at the corners to ensure they are leakproof or leak-resistant. Some versions contain screw holes for attachment to the underside of the tonneau cover lid at the top of the bellows, as well as attachment to the bed rail frame at the bottom. Hook-and-loop fasteners, zippers, metal-to-metal attachments can connect between the bellow 1300 and the truck or the bellows and the rigid cover 102.

What is claimed is:

1. A cargo-bed cover system, related to covering a cargo bed in a vehicle, comprising:
a rigid cover configured to cover the cargo bed;
a mechanically powered scissor lift assembly coupled to the rigid cover configured to vertically lift the rigid cover between a bed-covering position located adjacent the cargo bed and a raised position located above the cargo bed;
and
a mounting assembly configured to removably mount the mechanically powered scissor lift assembly to the cargo bed.

2. The cargo-bed cover system of claim 1, wherein the mechanically powered scissor lift assembly comprises a first-scissor-lift and a second-scissor-lift positioned on opposing sides of the cargo bed.

3. The cargo-bed cover system of claim 2, wherein the scissor lift assembly comprises an additional third-scissor-lift provided for additional support.

4. The cargo-bed cover system of claim 2, wherein the mechanically powered scissor lift assembly is electrically actuated.

5. The cargo-bed cover system of claim 4, wherein the mechanically powered scissor lift assembly comprises an electrical connector adapted to connect the mechanically powered scissor lift assembly to vehicle electric power.

6. The cargo-bed cover system of claim 1, further comprising a user-operable control unit configured to enable user control of the operation of the mechanically powered scissor lift assembly.

7. The cargo-bed cover system of claim 1, wherein the mounting assembly further comprises reinforcing members for installing underneath the rigid cover to reinforce the rigid cover.

8. The cargo-bed cover system of claim 1, wherein the rigid cover comprises a fiber-reinforced plastic composite.

9. The cargo-bed cover system of claim 1, wherein the rigid cover further comprises accessory receiving attachments configured to removably receive an accessory.

10. The cargo-bed cover system of claim 1, further comprises a roll-down bar including a flexible material.

11. The cargo-bed cover system of claim 1, further comprising enclosing side panels configured to enclose an area formed between a side portion of the rigid cover and the cargo bed when the rigid cover is in the raised position.

12. The cargo-bed cover system of claim 11, wherein an enclosing side panel(s) comprises a flexible sheet material.

13. The cargo-bed cover system of claim 1, wherein the mechanically powered scissor lift assembly further includes locking pins for securing the mechanically powered scissor lift assembly in position.

14. The cargo-bed cover system of claim 1, wherein the mechanically powered scissor lift assembly includes horizontal lifting actuators.

15. The cargo-bed cover system of claim 1, wherein the mounting assembly comprises a set of clamps adapted to releasably clamp the mounting assembly to the cargo bed.

16. The cargo-bed cover system of claim 1, wherein the mounting assembly includes:
a front frame section including a front-frame attacher configured to removably attach the front frame section to a top surface of a front wall of the cargo bed,
a first sidewall-frame section including a first-sidewall-frame attacher configured to removably attach the first sidewall frame section to a top surface of a first sidewall of the cargo bed,
and
a second sidewall-frame section including a second-sidewall-frame attacher configured to removably attach the second sidewall frame section to a top surface of a second sidewall of the cargo bed.

17. A cargo-bed cover system, related to covering a vehicle cargo bed, the cargo-bed cover system comprising:
a rigid cover configured to cover the cargo bed;
coupled to the rigid cover, a mechanically powered scissor lift assembly configured to vertically lift the rigid cover between a bed-covering position located adjacent the cargo bed and a raised position located above the cargo bed;
a user-operable control unit configured to operate the mechanically powered scissor lift assembly;
and
a mounting assembly configured to removably mount the mechanically powered scissor lift assembly to the cargo bed;
wherein
the mechanically powered scissor lift assembly comprises a first-scissor-lift and a second-scissor-lift positioned on opposing sides of the cargo bed;
the mechanically powered scissor lift assembly is electrically actuated;
the mechanically powered scissor lift assembly comprises an electrical connector adapted to connect the mechanically powered scissor lift assembly to vehicle electrical power;
the mounting assembly further comprises reinforcing members for installing underneath the rigid cover to reinforce the rigid cover;
the rigid cover further comprises accessory receiving attachments configured to removably receive an accessory;
the mechanically powered scissor lift assembly further includes locking pins for securing the mechanically powered scissor lift assembly in position;
and
the mechanically powered scissor lift assembly includes lifting actuators configured to move said mechanically powered scissor lift assembly horizontally.

18. The cargo-bed cover system of claim 1, wherein the vehicle is a pickup truck.

19. A cargo-bed cover method comprising:
providing a rigid cover configured to cover the cargo bed;
providing a mechanically powered scissor lift assembly configured to vertically lift the rigid cover between a bed-covering position located adjacent the cargo bed and a raised position located above the cargo bed;
operably coupling the mechanically powered scissor lift assembly to the rigid cover;
and
providing a mounting assembly configured to removably mount the mechanically powered scissor lift assembly to the cargo bed.

20. The method of claim 19 further comprising uninstalling the rigid cover and the mechanically powered scissor lift assembly from the cargo bed.
